(19) United States
(12) Patent Application Publication
(10) Pub. No.: US 2025/0377956 A1
(43) Pub. Date: Dec. 11, 2025

(54) METHOD, DEVICE, AND COMPUTER PROGRAM PRODUCT FOR GENERATING EXECUTABLE SCRIPTS

(71) Applicant: DELL PRODUCTS L.P., ROUND ROCK, TX (US)

(72) Inventors: Qi WANG, Beijing (CN); Yuhong NIE, Beijing (CN); Yuefeng LI, Shanghai (CN); Lin GU, Beijing (CN); Weiyang LIU, Shanghai (CN); Yun ZHANG, Shanghai (CN); Qiang CHEN, Shanghai (CN)

(21) Appl. No.: 18/792,203

(22) Filed: Aug. 1, 2024

(30) Foreign Application Priority Data
Jun. 7, 2024 (CN) 202410740911.1

(51) Int. Cl. G06F 9/54

(52) U.S. Cl. CPC G06F 9/541

(57) ABSTRACT

The present disclosure relates to a method, a device, and a computer program product for generating an executable script. The method includes generating a plurality of API-based scripts based on a user demand and an API knowledge base. The method further includes checking executability of APIs called in the plurality of API-based scripts. The method further includes checking a correlation between the plurality of API-based scripts and the user demand. In addition, the method further includes generating a plurality of executable scripts in response to the completion of the checking of the executability and the correlation. In this way, the whole API-based script generation process can be automated, the efficiency of script generation is improved, and the validity, executability, and high correlation with the user demand of the generated scripts are ensured.

### TECHNICAL FIELD

The present invention relates to the field of computers, and more particularly, to a method, a device, and a computer program product for generating an executable script.

### BACKGROUND

A computer script is usually a text file written in an interpreted language, which contains a series of instructions and logic. These instructions can accomplish various tasks, such as manipulating data, controlling process flow, interacting with systems or other programs, and the like. Computer scripts can be easily modified and adjusted to adapt to scenarios of rapid development and flexible configuration.

Conventional methods for generating computer scripts include: manual writing, for example, using a text editor to write the code line by line according to a syntax rule of a selected scripting language (e.g., Python, Bash, and the like); filling in and modifying the content as needed based on a code template; automatically generating part or all of the script code using a code generation tool; generating relevant script code according to the interface and instance provided by a specific framework or library; and the like.

### SUMMARY OF THE INVENTION

Embodiments of the present invention provide a method, a device, and a computer program product for generating an executable script.

According to a first aspect of the embodiments of the present invention, there is provided a method for generating an executable script, which includes generating a plurality of API-based scripts based on a user demand and an API knowledge base. The method further includes checking executability of APIs called in the plurality of API-based scripts. The method further includes checking a correlation between the plurality of API-based scripts and the user demand. In addition, the method further includes generating a plurality of executable scripts in response to completion of the checking of the executability and the correlation.

According to a second aspect of the embodiments of the present invention, there is provided an electronic device, which includes:

at least one processor; and a memory coupled to the at least one processor and having instructions stored thereon. The instructions, when executed by the at least one processor, cause the electronic device to perform actions including generating a plurality of API-based scripts based on a user demand and an API knowledge base. The actions further include checking executability of APIs called in the plurality of API-based scripts. The actions further include checking a correlation between the plurality of API-based scripts and the user demand. In addition, the actions further include generating a plurality of executable scripts in response to completion of the checking of the executability and the correlation.

According to a third aspect of the embodiments of the present invention, there is provided a computer program product which is tangibly stored on a non-volatile computer-readable medium and includes machine-executable instructions. The machine-executable instructions, when executed, cause a machine to perform actions including generating a plurality of API-based scripts based on a user demand and an API knowledge base. The actions further include checking executability of APIs called in the plurality of API-based scripts. The actions further include checking a correlation between the plurality of API-based scripts and the user demand. In addition, the actions further include generating a plurality of executable scripts in response to completion of the checking of the executability and the correlation.

It should be understood that the content described in the Summary of the Invention section is neither intended to define key or essential features of the embodiments of the present disclosure, nor intended to limit the scope of the present disclosure. Other features of the present disclosure will become readily understood from the following descriptions.

### BRIEF DESCRIPTION OF THE DRAWINGS

The above and other features, advantages, and aspects of the embodiments of the present disclosure will become more apparent with reference to the accompanying drawings and the following detailed description. Throughout the accompanying drawings, the same or similar reference numerals always represent the same or similar elements. In the accompanying drawings:

FIG. 1 illustrates an example in which a script for backing up a virtual machine is generated by a user in a conventional case;

FIG. 2 illustrates a schematic diagram of an overall environment for implementing some embodiments of the present disclosure;

FIG. 3 illustrates a flow chart of a method for generating an executable script according to some embodiments of the present disclosure;

FIG. 4 illustrates a flow chart of another method for generating an executable script according to some embodiments of the present disclosure;

FIG. 5 illustrates a schematic diagram of a method for creating two agents in FIG. 4 according to some embodiments of the present disclosure;

FIG. 6 illustrates a schematic diagram of a method for creating two other agents in FIG. 4 according to some embodiments of the present disclosure;

FIG. 7 illustrates a schematic diagram for explaining an example of the method shown in FIG. 4 according to some embodiments of the present disclosure; and

FIG. 8 illustrates a schematic block diagram of an example device adapted to implement the embodiments of the present disclosure.

### DETAILED DESCRIPTION

Embodiments of the present disclosure will be described below in further detail with reference to the drawings. Although the accompanying drawings show some embodiments of the present disclosure, it should be understood that the present disclosure can be implemented in various forms, and should not be explained as being limited to the embodiments stated herein. Rather, these embodiments are provided for understanding the present disclosure more thoroughly and completely. It should be understood that the accompanying drawings and embodiments of the present disclosure are for exemplary purposes only, and are not intended to limit the scope of protection of the present disclosure.

In the description of the embodiments of the present disclosure, the terms “include,” “have,” and similar terms thereof should be understood as open-ended inclusion, that is, “including but not limited to.” The term “based on” should be understood as “based at least in part on.” The terms “embodiment,” “one embodiment,” or “this embodiment” should be understood as “at least one embodiment.”

As used herein, unless explicitly stated otherwise, the term “or” covers all possible combinations, unless not feasible. For example, if a component is described as including A or B, the component may include A, or B, or A and B, unless explicitly stated otherwise or not feasible. As a second example, if a component is described as including A, B, or C, the component may include A or B or C, or A and B, or A and C, or B and C, or A and B and C, unless explicitly stated otherwise or not feasible.

An application program interface (API) library (a resource library in which many APIs are collected) contains the interface definitions of multiple functional modules and related implementation code. These interfaces define methods, functions, attributes, and the like that can be called by external programs to achieve specific functions or operations. The API library has the following characteristics: functional integration, convenient for unified use by developers; reusability, improving development efficiency; normalization, providing consistent calling methods and interface specifications to standardize the development process; encapsulation, hiding internal implementation details and exposing only necessary interfaces; and version management, where with the update and improvement of functions, there may be different versions.

Although an API library provided by a supplier contains abundant public APIs, which allows the developers (advanced end users or users) to conveniently realize specific functions (without developing from scratch) and create various novel applications and services, the process of generating computer scripts based on the API library is often difficult and complicated for users. On the one hand, users need to learn a great number of API documents provided by the supplier, which leads to long time of preparation for generating scripts. On the other hand, it is also very difficult for users to convert original user demands into final executable scripts, which poses strict requirements on users in analysis and establishment of the relationship between their service demands and the APIs from the supplier.

In addition, the maintenance of the generated scripts is another pain point for users. Suppliers always update their public APIs to provide better services. However, for users, this means that in addition to the initial huge amount of document learning, additional reinforcement learning is required. If an update to an API affects the existing scripts of a user, for example, before the user updates the API correctly, the previously obtained scripts will not be usable. Because of the user's lack of API knowledge, it is not easy to respond and maintain their scripts quickly.

In view of this, the present disclosure provides a solution for generating an executable script. In the embodiments of the present disclosure, a plurality of API-based scripts are generated based on a user demand and an API knowledge base (a resource base dedicated to storing and managing relevant API information), and the executability of the APIs called in the plurality of scripts and the correlation between the plurality of scripts and the use demand are checked, thereby generating a plurality of executable scripts. Using this solution, the whole API-based script generation process can be automated, the efficiency of script generation is improved, and the validity, executability, and high correlation with the user demand of the generated scripts are ensured.

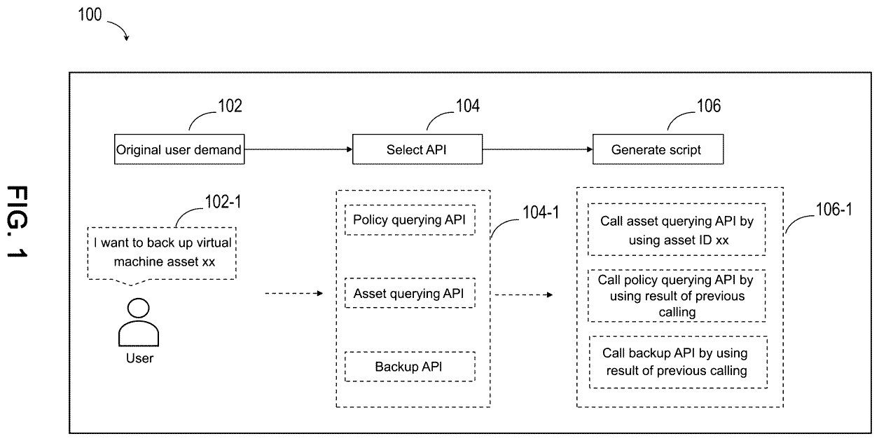

FIG. 1 illustrates an example 100 in which a script for backing up a virtual machine is generated by a user in a conventional case. In the example 100, the top row of solid line blocks shows the general process that the user needs to go through when generating a script in the conventional case. That is, in process 102, an original user demand is generated; in process 104, search is made and corresponding APIs are selected according to the original user demand; and in process 106, the selected APIs are combined in a specific order to ensure the executability, thus generating a script.

The dashed line blocks below show the process that the user goes through to generate a script for backing up a virtual machine. In process 102-1, the user generates a demand to back up the virtual machine asset xx. In process 104-1, the user accomplishes the function of backing up the virtual machine by analyzing his/her demand, searching related APIs, and then selecting a policy querying API, an asset querying API, and a backup API. In process 106-1, the three APIs are combined in the calling order as shown in the figure, that is, the asset querying API is called by using the asset ID xx, the policy querying API is called by using the result of calling the asset querying API, and the backup API is called by using the result of the policy querying API, thereby generating a script for backing up the virtual machine asset xx. According to this example, it can be found that the conventional manual script generation process poses strict requirements on users in analyzing and establishing the relationship between their service demands and APIs from suppliers. If users lack the knowledge of the APIs, it will take a long time to search the APIs, select the APIs, and combine the APIs in the calling order, resulting in inefficient script generation.

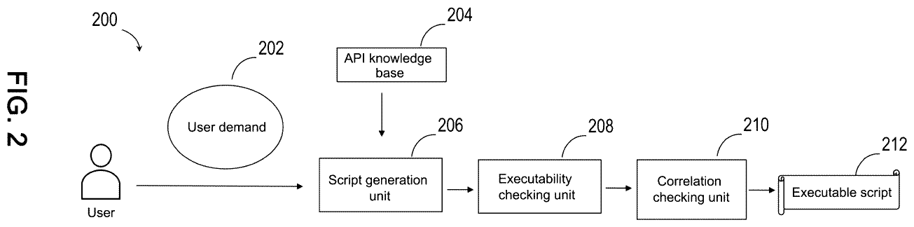

FIG. 2 illustrates a schematic diagram of an overall environment 200 for implementing some embodiments of the present disclosure. In the environment 200, a user inputs a user demand 202 to a script generation unit 206. The script generation unit 206 generates a plurality of API-based scripts according to the user demand 202 and an API knowledge base 204. The script generation unit 206 can extract information about the APIs from the API knowledge base 204 to ensure that the generated API-based scripts are in the API knowledge base, that is, have API validity. Because API knowledge can be “learned” by the script generation unit 206 (instead of the user), the time needed by the user to generate and maintain scripts is greatly saved, and the difficulty of script generation is greatly reduced.

In the environment 200, an executability checking unit 208 checks the dependencies among the APIs called (the relationship that requires other APIs for normal operation) in the generated scripts having API validity. If a script having API validity contains wrong dependency, lacks dependency, or has unnecessary dependency, even if the script is API valid, it cannot be executed on a computing device, that is, it does not have executability. Through the executability checking unit 208, it can be ensured that the generated scripts have executability.

In the environment 200, a correlation checking unit 210 checks the correlation between the generated scripts having API validity and the user demand 202. Even if a generated script has executability, it still has no practical significance when it has low correlation with the user demand 202. Therefore, through the correlation checking unit 210, it can be ensured that the scripts have high correlation with the user demand 202, and thus the executable scripts 212 that can meet the user demand can be obtained.

Through the embodiment described in connection with FIG. 2, in the method of the present disclosure, a user only needs to input the original demand, and an API-based script can be automatically generated, thus eliminating the learning and maintenance process for the user, improving the efficiency of script generation, and ensuring the validity, executability, and high correlation of the generated script with the user demand.

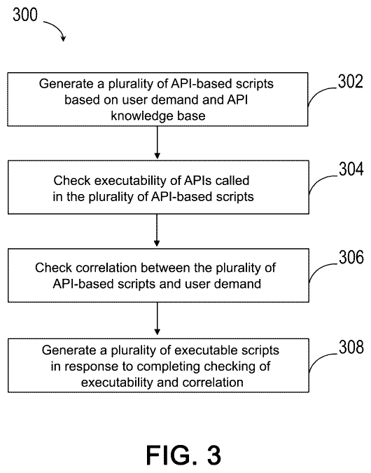

FIG. 3 illustrates a flow chart of a method 300 for generating an executable script according to some embodiments of the present disclosure. The method 300 can be performed in the environment 200 in FIG. 2. In addition, the numerals in the flow chart does not indicate the order in which these steps are performed. Some or all of these steps may be performed in parallel, or they may be interchanged in the performing order, which is not limited in the present disclosure.

In block 302, the method 300 can generate a plurality of API-based scripts based on the user demand and the API knowledge base. For example, in the environment 200 shown in FIG. 2, scripts with API validity are generated by the script generation unit 206 based on the user demand 202 and the API knowledge base 204. As the script generation unit 206 can obtain the API information in the API knowledge base 204 and restrain the APIs in the scripts within the API knowledge base according to such API information, it is ensured that the APIs in the generated scripts are valid APIs.

In block 304, the method 300 can check the executability of the APIs called in the plurality of API-based scripts. For example, in the environment 200 shown in FIG. 2, the API dependencies among the plurality of scripts having API validity are checked by the executability checking unit 208. As correct API dependencies determine whether the scripts can be executed, it can be found out whether the API dependencies are wrong, whether there is lack of API, whether there is an unnecessary API, and the like by checking the API dependencies in the plurality of scripts having API validity, so as to ensure the executability of the generated scripts.

In block 306, the method 300 can check the correlation between the plurality of API-based scripts and the user demand. For example, in the environment 200 shown in FIG. 2, the correlation between the plurality of scripts having API validity and the user demand 202 is checked by the correlation checking unit 210. As the correlation between the scripts and the user demand 202 determines whether the generated scripts can perform functions that meet the user demand 202, by checking the correlation between the plurality of scripts having API validity and the user demand 202, high correlation between the generated scripts and the user demand 202 can be ensured.

In block 308, the method 300 can generate a plurality of executable scripts in response to completing the checking of the executability and the correlation. For example, in the environment 200 shown in FIG. 2, in response to the executability checking unit 208 completing the dependency check on the plurality of scripts having API validity and in response to the correlation checking unit 210 completing the correlation check between the plurality of scripts having API validity and the user demand 202, an executable script 212 with high correlation that meets the user demand 202 is generated.

In this way, the automatic generation of API-based scripts is realized, the efficiency of API-based script generation is improved, and the validity, executability, and high correlation of the generated scripts with the user demand are ensured.

In the related technologies of script generation, although a direct artificial intelligence model can be established to simplify the process of generating API-based scripts for users, it is difficult to ensure the reliability of the generated scripts in this way, and the possibility of generating non-executable scripts is high. In addition, the generated scripts have low correlation with the original user demand. In other words, the generated scripts may be useless. Therefore, it is necessary to provide a solution that can automatically generate an executable script with high reliability.

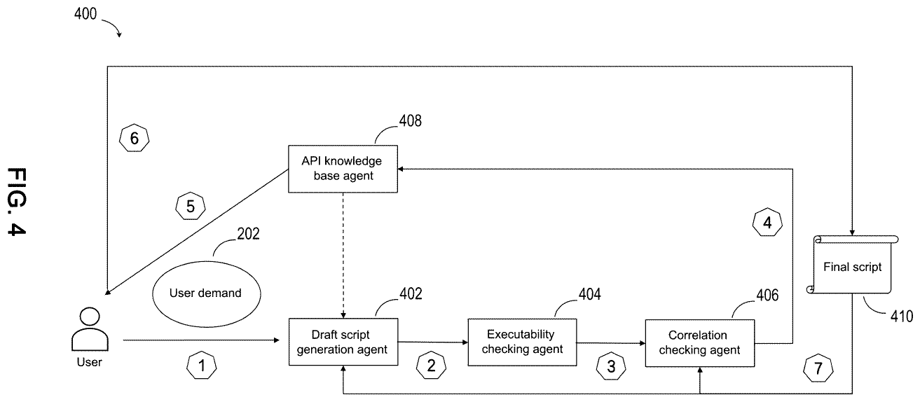

In view of this, in the embodiments of the present disclosure, a solution for automatically generating an API-based executable script is provided. As shown in FIG. 4, there is shown a flow chart of another method 400 for generating an executable script according to some embodiments of the present disclosure. A final script 410 meeting the user demand 202 is generated by a draft script generation agent 402, an executability checking agent 404, a correlation checking agent 406, and an API knowledge base agent 408. In FIG. 4, the numerals in the heptagon represent the performing sequence of the method 400.

In some embodiments, the user inputs his/her user demand 202 (e.g., the user demand “I want to back up the virtual machine asset xx” in FIG. 1) to the draft script generation agent 402 in the process with a numeral 1, and the draft script generation agent 402 generates a plurality of draft scripts having API validity according to the user demand 202 and the API knowledge acquired from the API knowledge base 408, and inputs the plurality of draft scripts having API validity to the executability checking agent 404 in the process with a numeral 2.

In some embodiments, in the process with a numeral 3, the executability checking agent 404 checks the dependencies among APIs in the plurality of draft scripts, and through this checking process, the plurality of draft scripts become a plurality of executable scripts. In the process with a numeral 4, the correlation checking agent 406 checks the correlation between the plurality of executable scripts and the user demand 202, and through this checking process, the plurality of executable scripts become reliable scripts. In the process with a numeral 5, the API knowledge base agent 408 converts the reliable scripts into scripts in natural language version that are convenient for users to read and use.

In some embodiments, in the process with a numeral 6, the user selects the script that best meets his/her user demand 202 among the scripts in natural language version as the final script 410, and scores the reliable script converted into the natural language by the API knowledge base agent 408. In the process with a numeral 7, the draft script generation agent 402 and the correlation checking agent 406 take the user demand 202, the final script 410, and the corresponding score as feedbacks to enhance the reliability of the method 400.

In this way, the whole API-based script generation process is automated by constructing a plurality of agents for generating scripts and ensuring their executability and reliability, thus eliminating the learning process and complicated and error-prone operations and difficult post-maintenance for the user, improving the efficiency of API-based script generation, and ensuring the validity, executability, and high correlation with user demand of the generated scripts through mechanisms of multiple checks and feedback enhancement for the scripts.

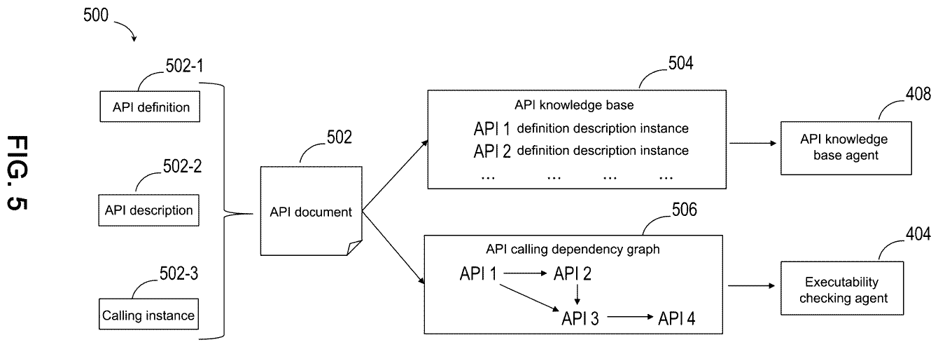

FIG. 5 illustrates a schematic diagram of a method 500 for creating the API knowledge base agent 408 and the executability checking agent 404 in FIG. 4 according to some embodiments of the present disclosure. In the method 500, as shown in FIG. 5, an API knowledge base 504 and an API calling dependency graph 506 can be created based on an API document 502, the API knowledge base agent 408 can be created based on the API knowledge base 504, and the executability checking agent 404 can be created based on the API calling dependency graph 506.

In the method 500, APIs and related features, functions, and the correspondence therebetween can be established based on at least the API definition 502-1, the API description 502-2, and the calling instance 502-3 included in API document 502, then the API knowledge base 504 can be built based on such correspondence, and thus an initialized version of the API knowledge base agent 408 can be created. In other words, the API knowledge base 504 at least includes API names, definitions, descriptions, and instances. For example, as shown in FIG. 5, the API knowledge base 504 includes API 1 and its definition, description, and instance; API 2 and its definition, description, and instance, and the like.

In some embodiments, the API knowledge base 504 may also include the following information: documents describing the functions, parameters, return values, calling methods, and the like, of the API in detail; specific instance code showing how to use a specific API; usage instructions including best practices, precautions, common problems, solutions, and the like; version information recording different versions of the API and variations thereof; and relevant technical data for technical background, principles, and other knowledge related to the API, and the like.

In the method 500, an API calling dependency graph 506 can be constructed based on at least the API definition 502-1 and the calling instance 502-3 included in the API document 502, and then an initial version of the executability checking agent 404 can be created based on the API calling dependency graph 506. The API calling dependency graph 506 includes the calling dependencies among the APIs. For example, as shown in FIG. 5, in the API calling dependency graph 506, API 2 depends on API 1, API 3 depends on API 1 and API 2, and API 4 depends on API 3, where API 2 acquires input from the output of API 1, API 3 acquires input from the outputs of API 1 and API 2, and API 4 acquires input from the output of API 3.

Although in FIG. 5, only one API calling dependency graph is shown in the API calling dependency graph 506, it is not intended to limit the number of API calling dependency graphs to one, and a plurality of them may be included; and although only the graph of dependencies among four APIs is shown, it is not intended to limit the graph of dependencies among four APIs to this graph, and a graph of API calling dependencies among another number of APIs is not excluded.

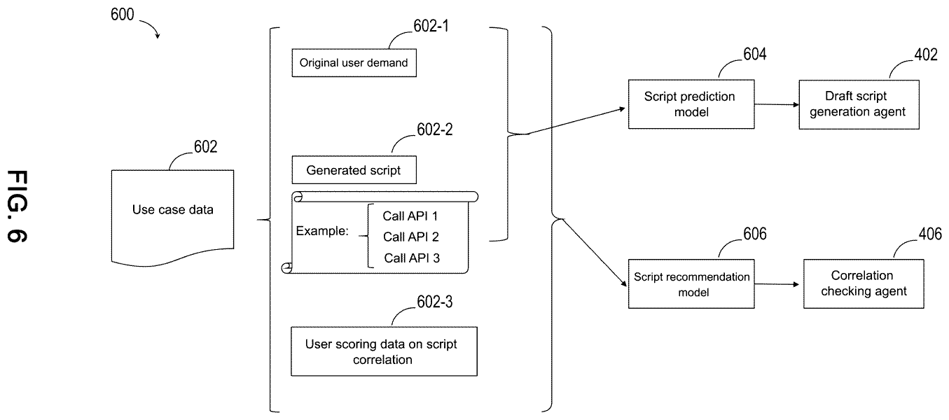

FIG. 6 illustrates a schematic diagram of a method 600 for creating the draft script generation agent 402 and the correlation checking agent 406 in FIG. 4 according to some embodiments of the present disclosure. In the method 600, as shown in FIG. 6, a script prediction model 604 and a script recommendation model 606 can be created based on use case data 602, the draft script generation agent 402 can be created based on the script prediction model 604, and the correlation checking agent 406 can be created based on the script recommendation model 606.

In the method 600, the script prediction model 604 can be created based on at least an original user demand 602-1 and a generated script 602-2 in the use case data 602 and by using the conventional natural language model processing, deep learning algorithm, or large language model, and then the initial version of the draft script generation agent 402 can be created. In some embodiments, the original user demand 602-1 and the generated script 602-2 can be used as the training data set for the script prediction model 604. The original user demand 602-1 may be, for example, “I want to back up the virtual machine asset xx” in the example of FIG. 1 or other demands, and the generated script 602-2 is a script with the correct API calling dependencies, such as calling API 1, API 2, and API 3 sequentially in the example script shown in FIG. 6 (the generated script 602-2 is not limited to this example script).

In the method 600, the script recommendation model 606 can be created based on at least the original user demand 602-1, the generated script 602-2, and the user scoring data on script correlation 602-3 in the use case data 602 and by using the conventional natural language model processing, deep learning algorithm, or large language model, and then an initial version of the correlation checking agent 406 can be created. In other words, the script recommendation model 606 at least includes the original user demand 602-1, the generated script 602-2, and the user scoring data on script correlation 602-3 in the use case data 602. In some embodiments, the original user demand 602-1, the generated script 602-2, and the user scoring data on script correlation 602-3 can be used as the training data set for the script recommendation model 606.

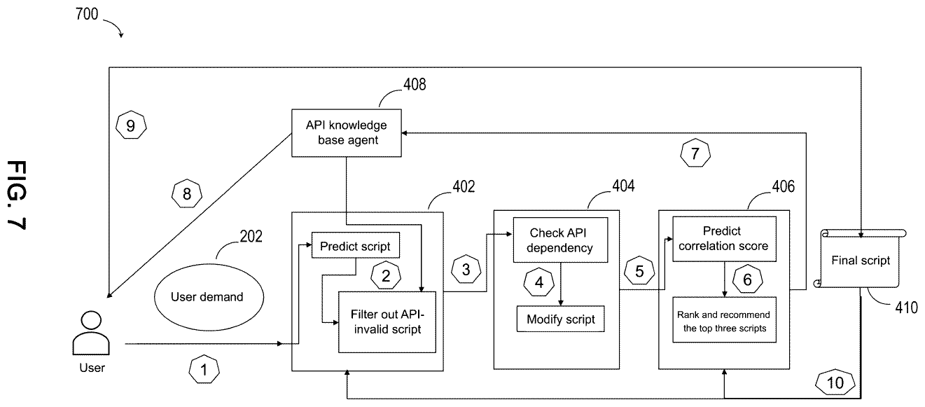

FIG. 7 illustrates a schematic diagram for explaining an example 700 of the method 400 according to some embodiments of the present disclosure. In the example 700, as shown in FIG. 7, the difference from FIG. 4 lies in that one or more operations performed in each agent are described in FIG. 7. In the process with a numeral 1, the user inputs the user demand 202 into the draft script generation agent 402, and the draft script generation agent 402 predicts a plurality of API-based draft scripts based on the user demand 202 with the aid of the script prediction model 604 (shown in FIG. 6). In the process with a numeral 2, the draft script generation agent 402 filters out scripts with an API that does not exist in the API knowledge base (i.e., API-invalid scripts) from the plurality of predicted API-based scripts based on the API knowledge acquired from the API knowledge base agent, thereby obtaining a plurality of draft scripts having API validity.

In the example 700, in the process with a numeral 3, the plurality of draft scripts having API validity are input into the executability checking agent 404. The executability checking agent 404 checks the dependencies among the APIs called in the plurality of draft scripts having API validity. Through this check, the executability checking agent 404 can know whether there are problems such as API calling dependency error, lack of API, unnecessary API, and the like in the plurality of draft scripts. In the process with a numeral 4, the executability checking agent 404 modifies the plurality of draft scripts according to the API calling dependency graph 506 to ensure the executability of these scripts, thereby obtaining a plurality of modified scripts with executability. Such modifications include adjusting the calling order of APIs in the draft scripts to the correct calling order, adding missing APIs in the API calling dependencies, and deleting redundant APIs in the API calling dependencies.

In the example 700, in the process with a numeral 5, the plurality of modified scripts are input into the correlation checking agent 406. The correlation checking agent 406 predicts the correlation score of each of the plurality of modified scripts with the user demand 202 based on the plurality of modified scripts and the user demand 202 with the aid of the script recommendation model 606 (shown in FIG. 6), and the higher the correlation score is, it means higher conformance of the script with the user demand 202. In the process with a numeral 6, the correlation checking agent 406 ranks the plurality of modified scripts based on the correlation score of each script with the user demand 202 with the aid of the script recommendation model 606, where a script with a higher correlation score is ranked higher. The script recommendation model 606 selects the top three scripts (or other ranking ranges, which is not limited by the embodiment of the present disclosure) as the reliable scripts.

In the example 700, in the process with a numeral 7, the reliable scripts are input into the API knowledge base agent 408. The API knowledge base agent 408 converts these reliable scripts into scripts in natural language (including description of multi-called APIs) to facilitate read and use by the user. In the process with a numeral 8, the scripts in natural language version are presented to the user. In the process with a numeral 9, the user selects the best script from these scripts according to his/her user demand 202, and scores the correlation between the best script and the user demand 202. In the process with a numeral 10, the correlation score, the user demand 202, and the best script will be fed back to the draft script generation agent 402 and the correlation checking agent 406 as use cases to enhance the performance of these two agents, thus continuously improving the reliability of the solution.

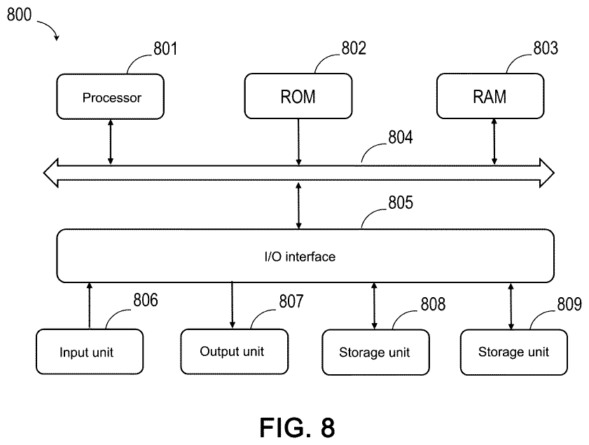

FIG. 8 shows a schematic block diagram of an example device 800 that can be used to implement the embodiments of the present disclosure. As shown in the figure, the device 800 includes a processor 801 that can perform various appropriate actions and processing according to computer program instructions stored in a read-only memory (ROM) 802 or computer program instructions loaded from a storage unit 808 to a random access memory (RAM) 803. Various programs and data required for the operation of the device 800 may also be stored in the RAM 803. The processor 801, the ROM 802, and the RAM 803 are connected to each other through a bus 804. An input/output (I/O) interface 805 is also connected to the bus 804.

A plurality of components in the device 800 are connected to the I/O interface 805, including: an input unit 806, such as a keyboard and a mouse; an output unit 807, such as various types of displays and speakers; the storage unit 808, such as a magnetic disk and an optical disc; and a communication unit 809, such as a network card, a modem, and a wireless communication transceiver. The communication unit 809 allows the device 800 to exchange information/data with other devices via a computer network, such as the Internet, and/or various telecommunication networks.

The processor 801 may be various general-purpose and/or special-purpose processing components with processing and computing capabilities. Some examples of the processor 801 include, but are not limited to, central processing units (CPUs), graphics processing units (GPUs), various specialized artificial intelligence (AI) computing chips, various processors for running machine learning model algorithms, digital signal processors (DSPs), and any appropriate processors, controllers, microcontrollers, and the like. The processor 801 performs various methods and processes described above, such as the method 300. For example, in some embodiments, the method 300 may be implemented as a computer software program that is tangibly included in a machine-readable medium such as the storage unit 808. In some embodiments, some or all of the computer program may be loaded and/or installed onto the device 800 via the ROM 802 and/or the communication unit 809. When the computer program is loaded onto the RAM 803 and executed by the processor 801, one or more steps of the method 300 described above can be performed. Alternatively, in other embodiments, the processor 801 may be configured to perform the method 300 by any other suitable manners (e.g., by means of firmware).

The functions described hereinabove may be executed at least in part by one or more hardware logic components. For example, without limitation, example types of hardware logic components that can be used include: a field programmable gate array (FPGA), an application specific integrated circuit (ASIC), an application specific standard product (ASSP), a system on chip (SOC), a load programmable logic device (CPLD), and the like.

Program code for implementing the method of the present disclosure can be written by using one programming language or any combination of multiple programming languages. The program code may be provided to a processor or controller of a general purpose computer, a special purpose computer, or another programmable data processing apparatus, such that the program code, when executed by the processor or controller, cause the functions/operations specified in the flow charts and/or block diagrams to be implemented. The program code may be executed completely on a machine, executed partially on a machine, executed partially on a machine and partially on a remote machine as a stand-alone software package, or executed completely on a remote machine or server.

In the context of the present disclosure, a machine-readable medium may be a tangible medium that may include or store a program for use by an instruction execution system, apparatus, or device or in connection with the instruction execution system, apparatus, or device. The machine-readable medium may be a machine-readable signal medium or a machine-readable storage medium. The machine-readable medium may include, but is not limited to, an electronic, magnetic, optical, electromagnetic, infrared, or semiconductor system, apparatus, or device, or any suitable combination thereof. More specific examples of the machine-readable storage medium may include one or more wire-based electrical connections, a portable computer diskette, a hard disk, a random access memory (RAM), a read-only memory (ROM), an erasable programmable read-only memory (EPROM or flash memory), an optical fiber, a portable compact disc read-only memory (CD-ROM), an optical storage device, a magnetic storage device, or any suitable combinations thereof. Additionally, although various operations have been depicted in a particular order, this should be understood that such operations are required to be performed in the particular order shown or in a sequential order, or that all illustrated operations should be performed to achieve desirable results. In certain environments, multitasking and parallel processing may be advantageous. Likewise, although the above discussion contains several specific implementation details, these should not be construed as limitations to the scope of the present disclosure. Certain features that are described in the context of separate embodiments may also be implemented in combination in a single implementation. In contrast, various features that are described in the context of a single implementation may also be implemented in a plurality of implementations separately or in any suitable sub-combination.

Although the present subject matter has been described using a language specific to structural features and/or method logical actions, it should be understood that the subject matter defined in the appended claims is not necessarily limited to the specific features or actions described above. Rather, the specific features and actions described above are merely example forms of implementing the claims.

1. A method for generating an executable script, comprising:
generating a plurality of application program interface (API)-based scripts based on a user demand and an API knowledge base;
checking executability of APIs called in the plurality of API-based scripts;
checking a correlation between the plurality of API-based scripts and the user demand; and
generating a plurality of executable scripts in response to completion of the checking of the executability and the correlation.

2. The method according to claim 1, wherein generating a plurality of API-based scripts based on a user demand and an API knowledge base comprises:
generating a plurality of scripts based on the user demand; and
obtaining the plurality of API-based scripts from the plurality of generated scripts based on the API knowledge base.

3. The method according to claim 2, wherein checking executability of APIs called in the plurality of API-based scripts comprises:
for the plurality of API-based scripts, checking dependencies among the called APIs; and
modifying the plurality of API-based scripts based on the dependencies among the APIs; and
obtaining modified scripts based on the modification of the plurality of API-based scripts.

4. The method according to claim 3, wherein checking a correlation between the plurality of API-based scripts and the user demand comprises:
determining a correlation score of each of the modified scripts based on the modified script and the user demand;
ranking each of the modified scripts based on the correlation score of each of the modified scripts; and
determining the modified scripts ranked within a threshold range as executable scripts.

5. The method according to claim 3, wherein modifying the plurality of API-based scripts comprises:
adjusting a calling order of the APIs; or
adding missing APIs; or
deleting redundant APIs.

6. The method according to claim 1, further comprising:
converting the plurality of executable scripts into a plurality of scripts in natural language; and
obtaining a user's correlation scores of the plurality of scripts in natural language with the plurality of executable scripts to be used as an enhanced feedback.

7. The method according to claim 1, further comprising:
generating, by the plurality of agents, the plurality of executable scripts.

8. The method according to claim 7, wherein generating, by the plurality of agents, the plurality of executable scripts comprises:
generating, by a script generation agent, a plurality of scripts based on the user demand;
obtaining, by an API knowledge base agent, a plurality of API-based scripts from the plurality of scripts;
obtaining, by an executability checking agent, modified scripts based on the dependencies among the APIs called in the plurality of API-based scripts; and
obtaining, by a correlation checking agent, the plurality of executable scripts based on the modified script and the user demand.

9. The method according to claim 8, further comprising:
converting, by the API knowledge base agent, the plurality of executable scripts into a plurality of scripts in natural language; and
feeding back the user's correlation scores of the plurality of scripts in natural language with the plurality of executable scripts and the plurality of executable scripts to the script generation agent and the correlation checking agent.

10. The method according to claim 8, wherein:
the script generation agent is based on a historical use case;
the API knowledge base agent is based on a public API document provided by a supplier;
the executability checking agent is based on the dependencies among the called APIs; and
the correlation checking agent is based on the historical use case and a corresponding historical score from the user.

11. An electronic device, comprising:
at least one processor; and
a memory coupled to the at least one processor and having instructions stored thereon, the instructions, when executed by the at least one processor, causing the electronic device to perform following operations:
generating a plurality of API-based scripts based on a user demand and an API knowledge base;
checking executability of APIs called in the plurality of API-based scripts;
checking a correlation between the plurality of API-based scripts and the user demand; and
generating a plurality of executable scripts in response to completion of the checking of the executability and the correlation.

12. The device according to claim 11, wherein generating a plurality of API-based scripts based on a user demand and an API knowledge base comprises:
generating a plurality of scripts based on the user demand; and
obtaining the plurality of API-based scripts from the plurality of generated scripts based on the API knowledge base.

13. The device according to claim 12, wherein checking executability of APIs called in the plurality of API-based scripts comprises:
for the plurality of API-based scripts, checking dependencies among the called APIs; and
modifying the plurality of API-based scripts based on the dependencies among the APIs; and
obtaining modified scripts based on the modification of the plurality of API-based scripts.

14. The device according to claim 13, wherein checking a correlation between the plurality of API-based scripts and the user demand comprises:
determining a correlation score of each of the modified scripts based on the modified script and the user demand;
ranking each of the modified scripts based on the correlation score of each of the modified scripts; and
determining the modified scripts ranked within a threshold range as executable scripts.

15. The device according to claim 13, wherein modifying the plurality of API-based scripts comprises:
adjusting a calling order of the APIs;
adding missing APIs; or
deleting redundant APIs.

16. The device according to claim 11, wherein the operations further comprise:
converting the plurality of executable scripts into a plurality of scripts in natural language; and
obtaining a user's correlation scores of the plurality of scripts in natural language with the plurality of executable scripts to be used as an enhanced feedback.

17. The device according to claim 11, wherein the operations further comprise:
generating, by the plurality of agents, the plurality of executable scripts.

18. The device according to claim 17, wherein the operations further comprise:
generating, by a script generation agent, a plurality of scripts based on the user demand;
obtaining, by an API knowledge base agent, a plurality of API-based scripts from the plurality of scripts;
obtaining, by an executability checking agent, modified scripts based on the dependencies among the APIs called in the plurality of API-based scripts; and
obtaining, by a correlation checking agent, the plurality of executable scripts based on the modified script and the user demand.

19. The device according to claim 18, wherein:
the script generation agent is based on a historical use case;
the API knowledge base agent is based on a public API document provided by a supplier;
the executability checking agent is based on the dependencies among the called APIs; and
the correlation checking agent is based on the historical use case and a corresponding historical score from the user.

20. A computer program product tangibly stored on a non-volatile computer-readable medium and comprising machine-executable instructions, the machine-executable instructions, when executed by a machine, causing the machine to:
generate a plurality of API-based scripts based on a user demand and an API knowledge base;
check executability of APIs called in the plurality of API-based scripts;
check a correlation between the plurality of API-based scripts and the user demand; and
generate a plurality of executable scripts in response to completion of the checking of the executability and the correlation.
